(19) United States
(12) Patent Application Publication
(10) Pub. No.: US 2012/0005032 A1
(43) Pub. Date: Jan. 5, 2012

(54) PAY-PER-RESTORE FOR DATA BACKUP RESTORATION

(75) Inventor: Richard Bunk, Veberod (SE)

(73) Assignee: SONY ERICSSON MOBILE COMMUNICATIONS AB, Lund (SE)

(21) Appl. No.: 12/826,757

(22) Filed: Jun. 30, 2010

(51) Int. Cl. G06Q 30/00; G06F 17/30

(52) U.S. Cl. 705/26.1; 707/640; 707/674

(57) ABSTRACT

A data repository receives a user's request to subscribe to a data backup service, and receives data from one or more remote devices associated with the user. The data repository stores the data in storage at the data repository, and receives a request to restore at least a portion of the data to one of the remote devices. The data repository determines, responsive to the request, a restoration fee for restoring the at least the portion of the data, and determines whether the user agrees to the restoration fee. The data repository charges the user the determined restoration fee if the user agrees to the fee, and provides the at least the portion of the data to the one of the remote devices.

### BACKGROUND

Within the field of information technology (IT), it has become commonplace to “back up” data from a device, such as a personal computer, such that the data may be restored to the computer after a data loss event. The process of “backing up” involves making copies of the data and storing the data at a location external to the device. Typically, “backing up” of data, for many IT users, has involved manually storing the data on removable computer-readable media (e.g., compact discs, external hard drives, etc.). Any lost data may be copied from the computer-readable media to the device from which the data was lost subsequent to the data loss event occurring.

### SUMMARY

In one exemplary embodiment, a method may include receiving, at a data repository, a user's request to subscribe to a data backup service, and receiving, at the data repository, data from one or more remote devices associated with the user. The method may further include storing the data in storage at the data repository, receiving a request to restore at least a portion of the data to one of the remote devices, and determining, by a processing unit associated with the data repository and responsive to the request, a restoration fee for restoring the at least the portion of the data. The method may also include determining, by the processing unit, whether the user agrees to the restoration fee, charging the user the determined restoration fee if the user agrees to the restoration fee, and providing, via a network, the at least the portion of the data to the one of the remote devices.

Additionally, determining the restoration fee may further include determining the restoration fee based on an amount of data contained in the portion of the data.

Additionally, determining the restoration fee may further include determining the restoration fee based on amount of data contained in the data received from the one of the remote devices.

Additionally, determining the restoration fee may further include determining the restoration fee based on a type of each of the one or more remote devices.

Additionally, determining the restoration fee may further include determining the restoration fee based on a number of the one or more devices or a length of time that the data was stored at the data repository.

Additionally, determining the restoration fee may further include determining the restoration fee based on a type of the data to be restored or based on a frequency that the data has been previously restored.

Additionally, the one or more remote devices may include multiple remote devices.

Additionally, the multiple remote devices may include at least two of a cellular radiotelephone, a game playing device, a media playing device, a laptop computer, a desktop computer, a notebook computer, a personal digital assistant (PDA), a tablet computer, a digital camera, or an electronic reader.

In another exemplary embodiment, a data repository device may include a data storage, a subscription control unit, and a fee determination unit. The subscription control unit may be configured to: receive a user's subscription to a data backup service, receive data from one or more remote devices associated with the user, store the data in the data storage, and receive a data restoration request from the user to restore at least the portion of the data to one of the one or more remote devices. The fee determination unit may be configured to determine, responsive to the request, a restoration fee for restoring the at least the portion of the data based on an amount of the data received from the one or more remote devices, or based on an amount of data contained in the at least a portion of the data. The subscription control unit may be further configured to: determine whether the user agrees to the restoration fee, charge the user the determined restoration fee if the user agrees to the fee, and restore the at least the portion of the data to the one of the one or more remote devices.

Additionally, when determining the restoration fee, the fee determination unit may be further configured to determine the restoration fee based on a type of each of the one or more devices.

Additionally, when determining the restoration fee, the fee determination unit may be further configured to determine the restoration fee based on a number of the one or more devices or a length of time that the data was stored at the data repository.

Additionally, the one or more remote devices may include multiple remote devices.

Additionally, the multiple remote devices may include at least two of a cellular radiotelephone, a game playing device, a media playing device, a laptop computer, a desktop computer, a notebook computer, a personal digital assistant (PDA), a tablet computer, a digital camera, or an electronic reader.

In yet another exemplary embodiment, a computer-readable medium containing instructions executable by at least one processing unit may include one or more instructions for receiving data from a remote device associated with a user, and one or more instructions for storing the data in storage as a data backup. The computer-readable medium may further include one or more instructions for receiving a request to restore at least a portion of the data to the remote device, and one or more instructions for determining, responsive to the request, a fee for restoring the at least a portion of the data. The computer-readable medium may also include one or more instructions for providing the at least the portion of the data to the remote device if the user pays the fee, or agrees to pay the fee, for restoring the at least a portion of the data.

Additionally, the one or more instructions for determining the fee further may further include one or more instructions for determining the fee based on an amount of data contained in the portion of the data.

Additionally, the one or more instructions for determining the fee may further include one or more instructions for determining the fee based on an amount of data contained in the data received from the remote device or a length of time that the data was stored in the storage as the data backup.

Additionally, the one or more instructions for determining the fee may further include one or more instructions for determining the fee based on a type associated with the remote device.

Additionally, the computer-readable medium may further include one or more instructions for receiving data from multiple remote devices associated with the user.

Additionally, the multiple remote devices may include at least two of a cellular radiotelephone, a game playing device, a media playing device, a laptop computer, a desktop computer, a notebook computer, a personal digital assistant (PDA), a tablet computer, a digital camera, or an electronic reader.

Additionally, the one or more instructions for determining the fee further include one or more instructions for determining the fee based on a number of the multiple remote devices associated with the user.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 is a diagram that illustrates an overview of the restoration of backed up data to a device from a backup data repository;

FIGS. 2A, 2B and 2C illustrate a network environment in which data backups and data restoration may occur according to exemplary embodiments;

FIG. 3 is a block diagram that depicts exemplary components of the backup data repository of FIG. 1;

FIG. 4 depicts exemplary functional components of the backup data repository of FIG. 1;

FIG. 5 is a flow diagram illustrating an exemplary process for subscribing to a data backup service, and for charging a user a determined fee for restoring backed up data to a selected device of the user;

FIG. 6 is a diagram that depicts an exemplary user interface that may be used to enroll in a data backup service and to select devices and data to be backed up; and

FIG. 7 is a diagram that depicts an exemplary user interface that may be used to select backed up data to be restored, and to identify a fee for restoring the selected backed up data to a user's device.

### DETAILED DESCRIPTION

The following detailed description refers to the accompanying drawings. The same reference numbers in different drawings may identify the same or similar elements. Also, the following detailed description does not limit the invention.

Data backups may be useful to restore data following a catastrophic disaster (e.g., hard-drive failure) or to restore small numbers of files after they have been accidently deleted or corrupted. On-line data backup systems may be used for data backup where a centralized data backup system may receive data for backup for a device via a network (e.g., via the Internet) and may then store the data in a data repository for subsequent restoration to the device. The data that is backed up in the data repository may be manually sent from the device via the network, or may be automatically retrieved by the centralized data backup system at, for example, intervals specified by the device user.

Exemplary embodiments described herein permit a user to subscribe to a data backup service for free, or for a nominal fee, and then to pay a per-restore fee at the time that the user wishes to restore the backed up data to a device subsequent to a data loss event. Thus, the data backup service may initially be free (or of very low cost) to the user wishing to back up device data, and the user only has to pay a restoration fee to restore the backed up data if and when a data loss event occurs. The fee to restore the backed up data may be based, for example, on the amount of data originally backed up by the user or based on the amount of data requested to be restored by the user to a specific device.

### Overview

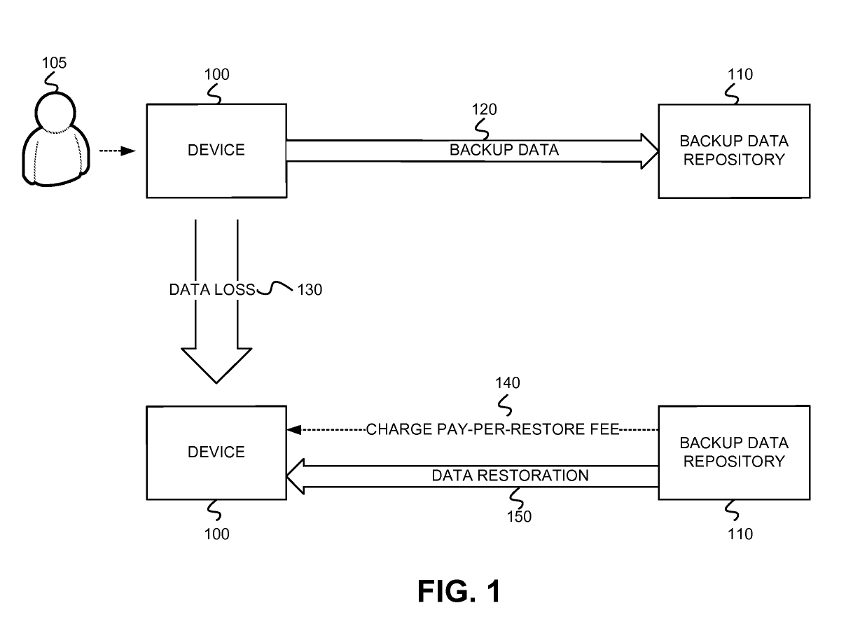

FIG. 1 illustrates an overview of the restoration of backed up data to a device from a backup data repository according to exemplary embodiments. A user 105 associated with a device 100 may subscribe to a data backup service and, as part of the service, backup data 120 may be sent from device 100 to a backup data repository 110, or retrieved from device 100 by backup data repository 110, via a network (not shown). In some embodiments, the subscription to the data backup service may be free, or may involve only a nominal charge to user 105. Thus, backing up data at backup data repository may involve little or no initial cost to user 105. Device 100 may include any type of electronic device that stores digital data, and which may include mechanisms to connect to an external network. For example, device 100 may include a cellular radiotelephone, a media playing device (e.g., an MP3 player), a game playing device, a laptop computer, a notebook computer, a desktop computer, a personal digital assistant (PDA), a tablet computer, a digital camera, or an electronic reader.

Subsequent to a data loss event 130 at device 100, backup data repository 110 may charge a pay-per-restore fee 140 to user 105 to restore the lost data to device 100. Data restoration 150 from repository 110 to device 100 may occur subsequent to user 105 paying fee 140. Thus, in accordance with an exemplary implementation, only at the time that user 105 requires restoration of any data backed up at backup data repository 110, may any fee be charged to user 105. The pay-per-restore fee 140 may be determined based on a number of factors including, for example, an amount of data originally backed up at repository 110 or an amount of data requested to be restored from repository 110 to device 100. Pay-per-restore fee 140 may be further determined based on other factors, described further below.

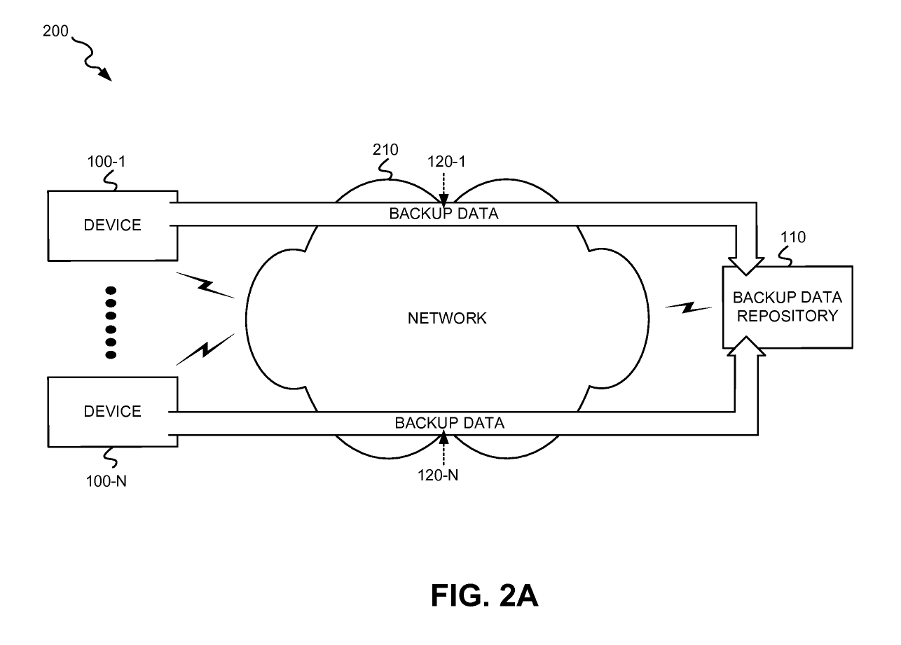

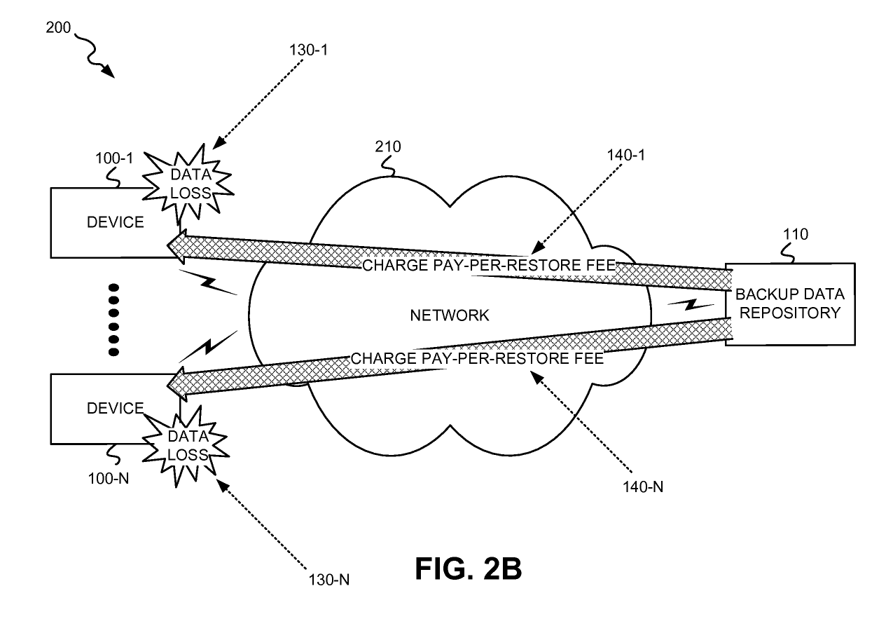

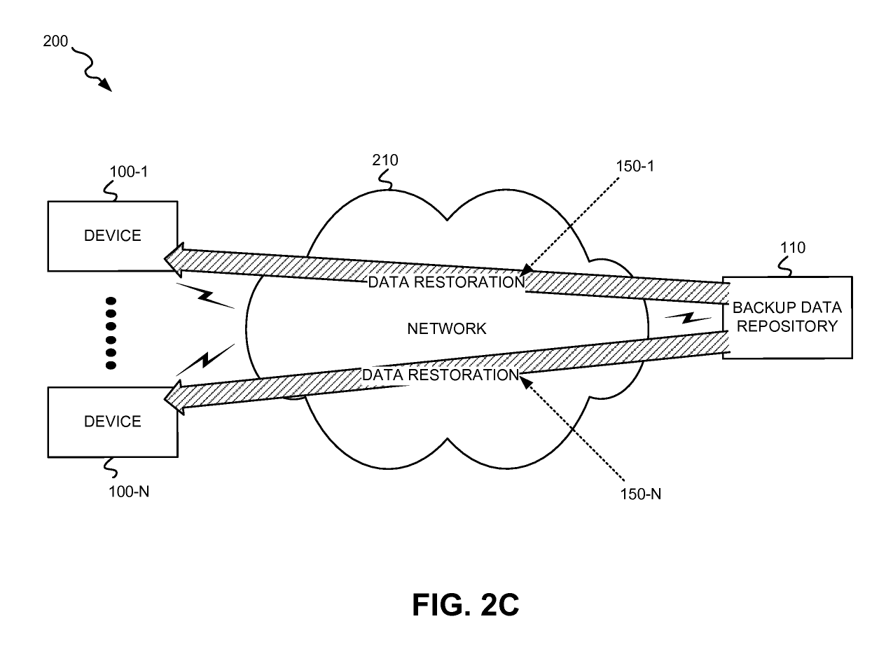

FIGS. 2A, 2B and 2C illustrate a network environment 200 in which data backups and data restoration may occur according to exemplary embodiments. As shown in FIG. 2A, network environment 200 may include one or more devices 100-1 through 100-N, a network 210 and backup data repository 110. Devices 100-1 through 100-N may each be associated with a different user (not shown), or multiple ones of devices 100-1 through 100-N may be associated with a single user. For example, devices 100-1 through 100-3 may include a cell phone, an MP3 player, and a laptop computer that are owned by a single user. Devices 100-1 through 100-N and backup data repository 110 may connect to network 210 via wired or wireless links

Network 210 may include one or more networks of any type, such as, for example, a local area network (LAN), a wide area network (WAN), a metropolitan area network (MAN), an intranet, the Internet, a wireless satellite network, a cable network (e.g., an optical cable network), and/or one or more wireless public land mobile networks (PLMNs). The PLMN(s) may include a Code Division Multiple Access (CDMA) 2000 PLMN, a Global System for Mobile Communications (GSM) PLMN, a Long Term Evolution (LTE) PLMN and/or other types of PLMNs not specifically described herein.

As shown in FIG. 2A, subsequent to subscribing to a data backup service provided by backup data repository 110, backup data 120-1 through 120-N from each respective device 100-1 through 100-N may be stored at backup data repository 110.

FIG. 2B further depicts the occurrence of a respective data loss event 130-1 through 130-N at devices 100-1 through 100-N. Upon the occurrence of data loss event 130, a respective device 100 may communicate (not shown) with backup data repository 110 to request the restoration of selected portions of previously backed up data. Upon receipt of the request, backup data repository 110 may charge respective pay-per-restore fees 140-1 through 140-N to devices 100-1 through 100-N.

Subsequent to payment of the corresponding pay-per-restore fee 140 by a user associated with a respective device 100, backup data repository 110 may, as depicted in FIG. 2C, perform data restoration 150 to restore selected data to a device 100 that has suffered a data loss event 130. For example, as shown in FIG. 2C, backup data repository 110 may perform data restoration 150-1 with device 100-1, and data restoration 150-N with device 100-N.

### Exemplary Backup Data Repository

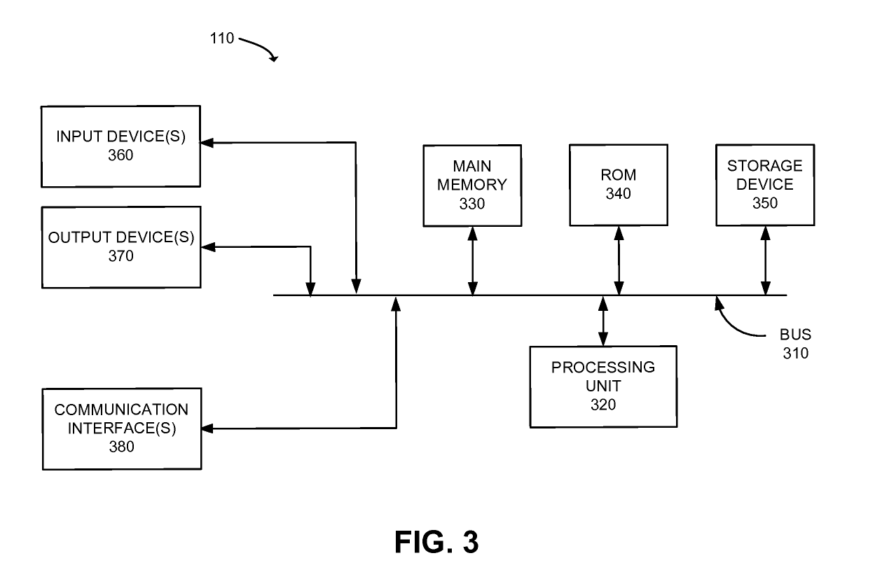

FIG. 3 is a block diagram that depicts exemplary components of backup data repository 110. Devices 100-1 through 100-N may each be similarly configured. As illustrated, repository 110 may include a bus 310, a processing unit 320, a main memory 330, a read only memory (ROM) 340, a storage device 350, an input device(s) 360, an output device(s) 370, and a communication interface(s) 380. Bus 310 may include a path that permits communication among the elements of device 110.

Processing unit 320 may include one or more processors or microprocessors, or processing logic that may interpret and execute instructions. Main memory 330 may include a random access memory (RAM) or another type of dynamic storage device that may store information and instructions for execution by processing unit 320. ROM 340 may include a conventional ROM device or another type of static storage device that may store static information and instructions for use by processing unit 320. Storage device 350 may include a magnetic and/or optical recording medium and its corresponding drive.

Input device 360 may include a mechanism that permits a user to input information to repository 110, such as a mouse, a pen, voice recognition and/or biometric mechanisms, etc. Output device 370 may include a mechanism that outputs information to the operator, including a display, a printer, a speaker, etc. Communication interface 380 may include any transceiver-like mechanism that enables repository 110 to communicate with other devices and/or systems. For example, communication interface 380 may permit repository 110 to communicate with devices 100-1 through 100-N via network 210.

Repository 110 may perform certain operations or processes described herein. Repository 110 may perform these operations in response to processing unit 320 executing software instructions contained in a computer-readable medium, such as memory 330. A computer-readable medium may be defined as a physical or logical memory device. Each of main memory 330, ROM 340 and storage device 350 may include computer-readable media. The magnetic and/or optical recording media (e.g., readable CDs or DVDs) of storage device 350 may also include computer-readable media.

The software instructions may be read into memory 330 from another computer-readable medium, such as data storage device 350, or from another device via communication interface 380. The software instructions contained in memory 330 may cause processing unit 320 to perform operations or processes described herein. Alternatively, hardwired circuitry may be used in place of or in combination with software instructions to implement processes described herein. Thus, implementations described herein are not limited to any specific combination of hardware circuitry and software. Repository 110 may include additional, fewer, and/or different components, or differently configured components, than those depicted in FIG. 3.

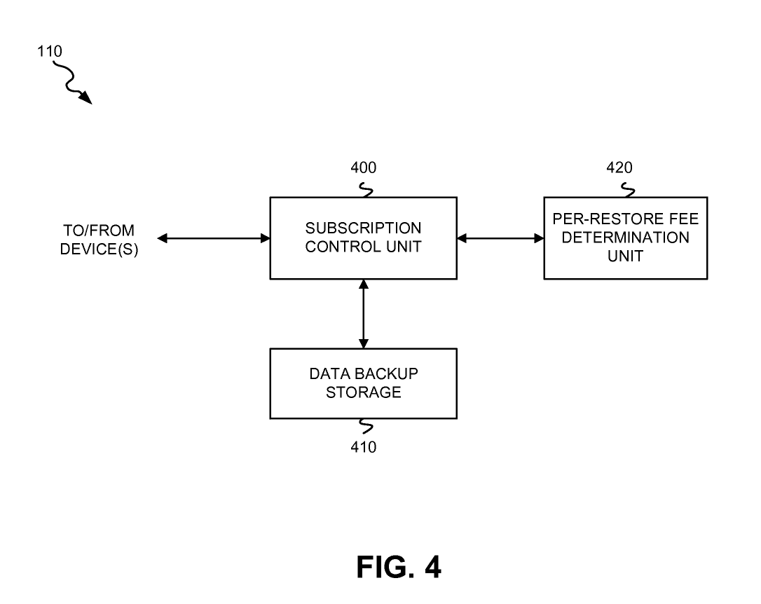

FIG. 4 depicts exemplary functional components of repository 110. The functional components depicted in FIG. 4 may be implemented, for example, by processing unit 320 in conjunction with other components of repository 110 shown in FIG. 3.

The functional components of repository 110 may include a subscription control unit 400, data backup storage 410, and a per-restore fee determination unit 420. Subscription control unit 400 may receive and process user requests to subscribe to a data backup service, and user requests to restore previously backed up data. Subscription control unit 400 may handle data sent to, or received from, per-restore fee determination unit 420 and data backup storage 410, and may process user data restoration requests. The user subscription requests may include, for example, credit or debit card information such that subscription control unit 400 may apply fee charges to a user's credit or debit cards at the time that data restoration of backed up data is requested by the user.

Data backup storage 410 may store a data structure (e.g., a database) that further may store data backups associated with respective devices of users. The data structure may store additional data associated with each user including, for example, credit or debit card information, device network address information (e.g., cell phone number if device is a cell phone, Internet Protocol (IP) address if the device is a media player, computer, PDA, tablet or e-reader). Data backup storage 410 may be implemented by main memory 330, or by storage device 350.

Per-restore fee determination unit 420 may determine a fee to be charged to a user at the time that a user wishes to restore backed up data previously stored in data backup storage 410. Per-restore fee determination unit 420 may determine the fee based on various factors including, for example, the amount of data originally backed up by the user or the amount of data that the user requests to restore. The per-restore fee may be determined based on other factors described herein.

### Exemplary Data Restoration Process with a Per-Store Fee

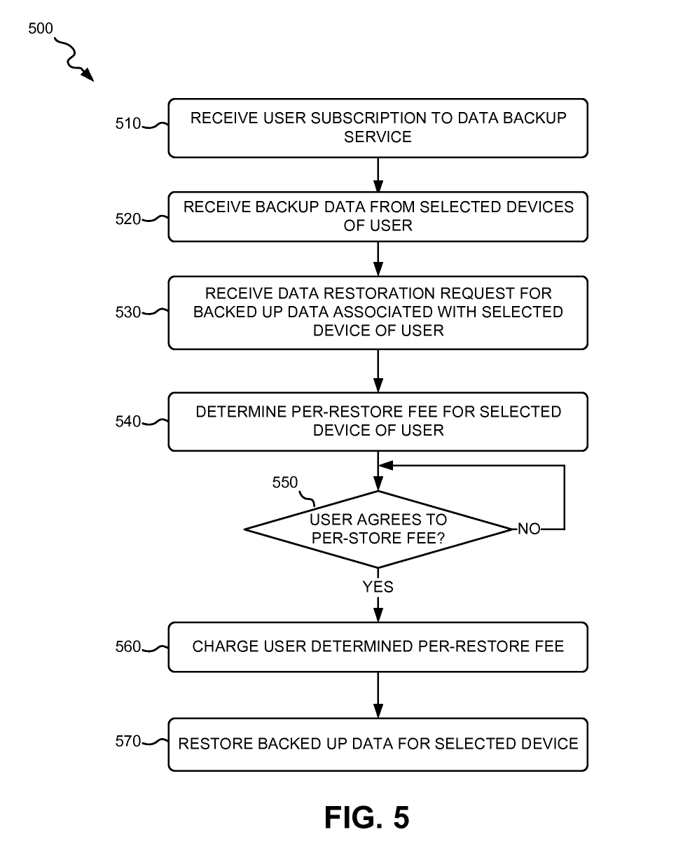

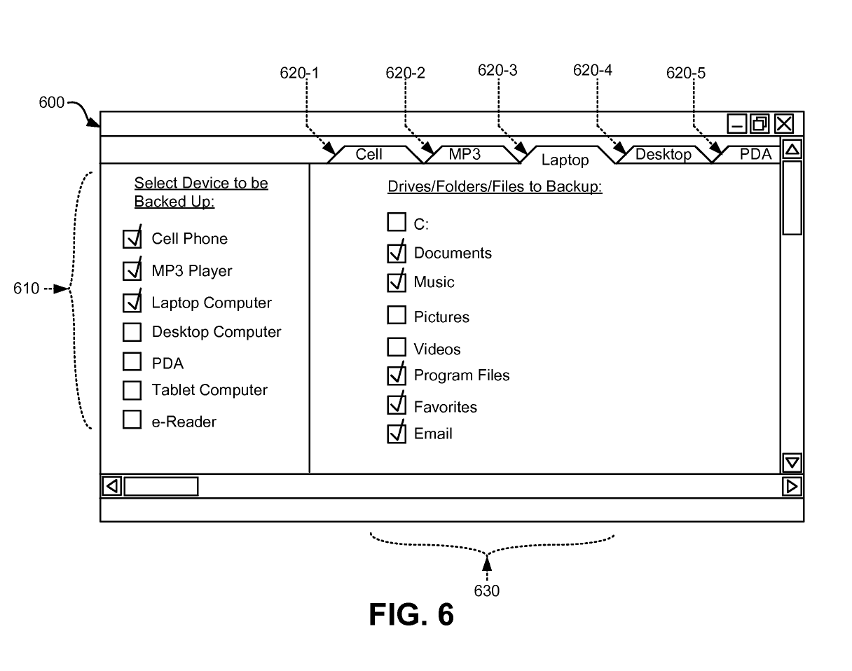

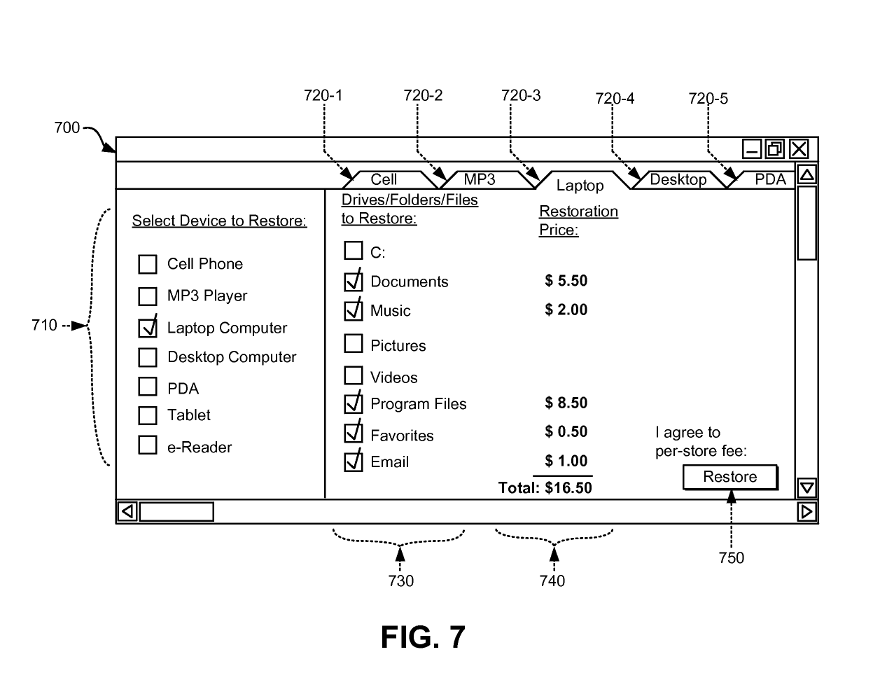

FIG. 5 is a flow diagram illustrating an exemplary process 500 for subscribing to a data backup service, and for charging a user a determined fee for restoring backed up data to a selected device of the user. The exemplary process of FIG. 5 may be performed by the exemplary components of repository 110 depicted in FIG. 4. The exemplary process of FIG. 5 is described with reference to the exemplary user interfaces depicted in FIGS. 6 and 7.

The exemplary process may include receiving a user's subscription to the data backup service (block 510). Subscription control unit 400 may receive and process the user subscription to the data backup service. For example, user 105 may, via network 210, request a subscription to the data backup service offered by backup data repository 110. User 105 may employ a web browser to access a web-site associated with the data backup service to subscribe to the service. Subscription to the data backup service may include providing identification information associated with user 105 (e.g., mailing address, phone number, email address, etc.), and providing charging information (e.g., credit/debit card number). During the initial subscription process, user 105 may be informed that the data backup service involves no initial cost (or possibly a nominal fee), but that user 105 will be charged at the time that any backed up data is restored to a selected device of user 105 after a data loss event occurs.

FIG. 6 depicts an exemplary user interface 600 that user 105 may use, via one of devices 100-1 through 100-N, to subscribe to the data backup service. As shown in FIG. 6, user interface 600 may include a window 610 that permits the user to select which devices the user wishes to have data backed up. For example, the user may own several different devices, such as a cell phone, a media player (e.g., an MP3 player), and a laptop computer. The user may select these devices from a list of devices presented in window 610.

As further shown in FIG. 6, user interface 600 may include tabbed windows 620-1 through 620-5, with one window for each device listed in window 610 that may have its data backed up. Each one of windows 620-1 through 620-5 may permit the user to select which data is to be backed up. For example, in the “laptop” tabbed window 620-3 shown in FIG. 6, the user may select from a list 630 of data to be backed up, including data stored on a certain drive (e.g, C: drive), documents, music, pictures, videos, program files, favorites, and email. Tabbed windows 620-1, 620-2, 620-4 and 620-5, for each of the different devices, may each include similar lists.

The backup data may be received from selected devices of the user (block 520). Device 100 may send, via network 210, the specified data to be backed up to backup data repository 110 (i.e., device 100 “pushes” the data out to repository 110). Alternatively, backup data repository 110 may, via network 210, retrieve the specified data to be backed up (i.e., repository 110 “pulls” the data from device 100) and may store the data. Subscription control unit 400 may receive the backup data and may store the data in data backup storage 410.

A data restoration request may be received for backed up data associated with a selected device of the user (block 530). Subscription control unit 400 may receive and process the data restoration request. For example, a data loss event may occur at a device 100, and the user may send a data restoration request, via network 210, to backup data repository 110. As shown in FIG. 7, the user may receive user interface 700 from backup data repository 110. As illustrated, device selection window 710 of user interface 700 may be used to select which device to have its data restored (e.g., a laptop computer shown in window 710 by way of example). The user may select an appropriate tabbed window of windows 720-1 through 720-5 to select what data, or types of data, from a list 730 of data to be restored from the previously backed up data for the selected device. The data restoration request of block 530 may be triggered manually by the user, as described above, or may be triggered by a restoration determining function (i.e., a function executed at device 100 or at backup data repository 110). The restoration determining function may trigger a data restoration request automatically based, for example, on the loss of data at device 100.

A per-restore fee may be determined for the selected device of the user (block 540). Per-restore fee determination unit 420 may determine the per-restore fee and may provide the determined fee to subscription control unit 400 for processing and provisioning to the user via network 210. The per-restore fee may be determined based on a number of factors, including, for example, an amount of data originally backed up at backup data repository 110 for the user (or for a given device), a length of time that the data has been stored, the amount of data to be restored to the device, a type of the data that is to be restored (e.g., a different fee may be charged for different types of data), a frequency (e.g., a total number of times) that the user has utilized the restoration service, etc. For example, an incremental fee may be determined for each 100 Megabytes of data backed up, or restored. The per-restore fee may also be based on the type of devices and/or number of devices for which data backup has been performed. For example, certain types of devices may have higher per-restore fees than other devices (e.g., media player costing more to back up than cell phones). As another example, the per-restore fee may be higher for each additional device backed up beyond a first number of devices (e.g., each additional device backup beyond two devices costs extra). Referring again to FIG. 7, a tabbed window 720-3 associated with the device selected to be backed up in window 710 may display an itemized fee list 740, including a total pre-restore fee, for the data selected from list 730 to be restored.

A determination may be made whether the user agrees to the per-restore fee (block 550). Referring again to FIG. 7, the user may select a “restore” button 750 if the user agrees to the per-store fee contained in fee list 740, and wishes to restore the data selected from list 730 to the device selected in window 710. If the user agrees to the per-restore fee (YES-block 550), then the user may be charged the determined per-restore fee (block 560). Backup data repository 110 may apply a charge to the user's credit or debit card equal to the per-restore fee determined in block 540. The backed up data for the selected device may be restored (block 570). For example, backup data repository 110 may send, via network 210, the requested backed up data to the device selected by the user for restoration at the device.

### Conclusion

Implementations described herein include a data backup service that allows users to subscribe to a data backup service for free (or for a low, nominal fee) and then to pay a per-restore fee only at the time that the user wishes to restore the backed up data to a device, such as subsequent to a data loss event. The user subscribing to the data backup service, therefore, only need pay a fee to restore the backed up data in the event that data loss for a device occurs. The fee to restore the backed up data may be based, for example, on the amount of data originally backed up by the user, on the amount of data requested to be restored by the user to a specific device, or on other factors, such as the length of time that the data has been backed up.

The foregoing description of the embodiments described herein provides illustration and description, but is not intended to be exhaustive or to limit the invention to the precise form disclosed. Modifications and variations are possible in light of the above teachings or may be acquired from practice of the invention. For example, while a series of blocks has been described with respect to FIG. 5, the order of the blocks may be varied in other implementations. Moreover, non-dependent blocks may be performed in parallel.

Certain features described herein may be implemented as “logic” or as a “unit” that performs one or more functions. This logic or unit may include hardware, such as one or more processors, microprocessors, application specific integrated circuits, or field programmable gate arrays, software, or a combination of hardware and software.

The term “comprises” or “comprising” as used herein, including the claims, specifies the presence of stated features, integers, steps, or components, but does not preclude the presence or addition of one or more other features, integers, steps, components, or groups thereof.

No element, act, or instruction used in the description of the present application should be construed as critical or essential to the invention unless explicitly described as such. Also, as used herein, the article “a” is intended to include one or more items. Further, the phrase “based on,” as used herein is intended to mean “based, at least in part, on” unless explicitly stated otherwise.

What is claimed is:

1. A method, comprising:
receiving, at a data repository, a user's request to subscribe to a data backup service;
receiving, at the data repository, data from one or more remote devices associated with the user;
storing the data in storage at the data repository;
receiving a request to restore at least a portion of the data to one of the remote devices;
determining, by a processing unit associated with the data repository and responsive to the request, a restoration fee for restoring the at least the portion of the data;
determining, by the processing unit, whether the user agrees to the restoration fee;
charging the user the determined restoration fee if the user agrees to the restoration fee; and
providing, via a network, the at least the portion of the data to the one of the remote devices.

2. The method of claim 1, wherein determining the restoration fee further comprises:
determining the restoration fee based on an amount of data contained in the portion of the data.

3. The method of claim 1, wherein determining the restoration fee further comprises:
determining the restoration fee based on amount of data contained in the data received from the one of the remote devices.

4. The method of claim 1, wherein determining the restoration fee further comprises:
determining the restoration fee based on a type of each of the one or more remote devices.

5. The method of claim 1, wherein determining the restoration fee further comprises:
determining the restoration fee based on a number of the one or more devices or a length of time that the data was stored at the data repository.

6. The method of claim 1, wherein determining the restoration fee further comprises:
determining the restoration fee based on a type of the data to be restored or based on a frequency that the data has been previously restored.

7. The method of claim 1, wherein the one or more remote devices comprise multiple remote devices.

8. The method of claim 7, wherein the multiple remote devices comprise at least two of a cellular radiotelephone, a game playing device, a media playing device, a laptop computer, a desktop computer, a notebook computer, a personal digital assistant (PDA), a tablet computer, a digital camera, or an electronic reader.

9. A data repository device, comprising:
a data storage;
a subscription control unit configured to:
receive a user's subscription to a data backup service,
receive data from one or more remote devices associated with the user,
store the data in the data storage,
receive a data restoration request from the user to restore at least the portion of the data to one of the one or more remote devices; and
a fee determination unit configured to:
determine, responsive to the request, a restoration fee for restoring the at least the portion of the data based on an amount of the data received from the one or more remote devices, or based on an amount of data contained in the at least a portion of the data;
where the subscription control unit is further configured to:
determine whether the user agrees to the restoration fee,
charge the user the determined restoration fee if the user agrees to the fee, and
restore the at least the portion of the data to the one of the one or more remote devices.

10. The data repository device of claim 9, wherein, when determining the restoration fee, the fee determination unit is further configured to:
determine the restoration fee based on a type of each of the one or more devices.

11. The data repository device of claim 9, wherein, when determining the restoration fee, the fee determination unit is further configured to:
determine the restoration fee based on a number of the one or more devices or a length of time that the data was stored at the data repository.

12. The data repository of claim 9, wherein the one or more remote devices comprise multiple remote devices.

13. The data repository of claim 12, wherein the multiple remote devices comprise at least two of a cellular radiotelephone, a game playing device, a media playing device, a laptop computer, a desktop computer, a notebook computer, a personal digital assistant (PDA), a tablet computer, a digital camera, or an electronic reader.

14. A computer-readable medium containing instructions executable by at least one processing unit, the computer-readable medium comprising:
one or more instructions for receiving data from a remote device associated with a user;
one or more instructions for storing the data in storage as a data backup;
one or more instructions for receiving a request to restore at least a portion of the data to the remote device;
one or more instructions for determining, responsive to the request, a fee for restoring the at least a portion of the data; and
one or more instructions for providing the at least the portion of the data to the remote device if the user pays the fee, or agrees to pay the fee, for restoring the at least a portion of the data.

15. The computer-readable medium of claim 14, wherein the one or more instructions for determining the fee further comprises:
one or more instructions for determining the fee based on an amount of data contained in the portion of the data.

16. The computer-readable medium of claim 14, wherein the one or more instructions for determining the fee further comprises:
one or more instructions for determining the fee based on an amount of data contained in the data received from the remote device or a length of time that the data was stored in the storage as the data backup.

17. The computer-readable medium of claim 14, wherein the one or more instructions for determining the fee further comprises:
one or more instructions for determining the fee based on a type associated with the remote device.

18. The computer-readable medium of claim 14, further comprising:
one or more instructions for receiving data from multiple remote devices associated with the user.

19. The computer-readable medium of claim 18, wherein the multiple remote devices comprise at least two of a cellular radiotelephone, a game playing device, a media playing device, a laptop computer, a desktop computer, a notebook computer, a personal digital assistant (PDA), a tablet computer, a digital camera, or an electronic reader.

20. The computer-readable medium of claim 18, wherein the one or more instructions for determining the fee further comprises:
one or more instructions for determining the fee based on a number of the multiple remote devices associated with the user.
